(19) United States
(12) Patent Application Publication
(10) Pub. No.: US 2013/0157048 A1
(43) Pub. Date: Jun. 20, 2013

(54) SEALING MEMBRANE WITH IMPROVED ADHESION

(71) Applicant: Jean-Claude Rudolf, Horw (CH)

(72) Inventor: Jean-Claude Rudolf, Horw (CH)

(73) Assignee: SIKA TECHNOLOGY AG, Baar (CH)

(21) Appl. No.: 13/819,906

(22) PCT Filed: Sep. 12, 2011
(86) PCT No.: PCT/EP2011/065785

§ 371 Date: Feb. 28, 2013

(30) Foreign Application Priority Data
Sep. 13, 2010 (EP) 10176346.4

(51) Int. Cl. B32B 27/08

(52) U.S. Cl. CPC B32B 27/08
USPC 428/339; 156/308.2; 264/175; 428/349; 428/414

(57) ABSTRACT

The invention relates to a sealing membrane comprising a thermoplastic barrier layer and a tack-free solid epoxy resin layer which is suitable for sealing substrates in the construction industry. The invention further relates to a method for sealing said substrates. Said method allows rapid and efficient sealing of structures in civil engineering and good adhesion of the sealing membrane on the substrate.

### TECHNICAL AREA

The invention relates to the area of sealing substrates, especially in the construction industry.

### PRIOR ART

Substrates that must be sealed against water, in particular concrete structures, are often present in civil engineering. Such substrates are typically sealed by bituminous webs or plastic webs in combination with bitumen. However, due to the thermoplastic behavior, bituminous webs are susceptible to temperature variations. Elastic plastic webs, on the other hand, have an elastic behavior that is constant over a broad temperature range and therefore meet their function as a seal even under extreme temperature conditions. However, in the case of a plastic web in combination with bitumen there is the problem that a good adhesive bond must be present between the plastic web in combination with bitumen and the substrate, which naturally also comprises the adhesions of all intermediate layers. In particular, the adhesion and compatibility between the plastic sheet and the bitumen poses a problem that is very difficult to solve on account of the materials involved.

Furthermore, this system has the great disadvantage that a great amount of heat must be provided for the complete melting, which typically requires the using of an open flame. This is on the one hand expensive and on the other hand the high heat output of such an open flame, that is difficult to control, can lead to smoldering fires. Furthermore, this system requires that after the melting of the bitumen in the case that a plastic web is used, the plastic web must be immediately applied thereafter, which makes a previously positioning of the plastic web impossible. In addition, walking on the substrate after the melting of the bitumen for the application of the sealing material is not possible.

### PRESENTATION OF THE INVENTION

The present invention therefore has the problem of making a sealing membrane available that does not have the disadvantages of the prior art, can be prepared and applied in an especially simple and economical manner and leads to a good adhesive bond between the sealing membrane and the substrate. Furthermore, a high degree of tightness to water should be ensured.

It surprisingly turned out that this problem can be solved with a sealing membrane. Such a sealing membrane allows a substrate, in particular a concrete structure, to be sealed in a rapid and cost-efficient manner.

The core of the present invention is a combination of a thermoplastic barrier layer and of a tack-free solid epoxy resin layer as essential components of a sealing membrane.

It furthermore turned out that a significant problem of the prior art, namely, a uniform and controlled application of the adhesive agent, bitumen, can be readily avoided with the preferred embodiments and thus the assurance of quality can be readily increased when preparing a sealing.

There is another great advantage here in that the necessary adhesive agent can be distributed and fixed in a controlled manner on the thermoplastic barrier layer in an industrial process, and that this thermoplastic barrier layer with adhesive agent, namely, a tack-free solid epoxy resin layer, can be brought previously prepared for use on the construction site. It is especially advantageous that using a cast bitumen can be dispensed with.

Furthermore, such sealing membranes are not dependent on bitumen-compatible barrier layer materials. “Bitumen-compatible plastic” typically denotes plastic in this document into which bitumen penetrates only slightly or not at all, or also plastic free of softeners. Softeners can migrate into the bitumen, as a result of which the plastic can become brittle or be otherwise adversely affected in its qualities. The penetration of bitumen into plastic can lead to a discoloration of the plastic, which is evaluated, for example, in a visible seal as a disadvantage of such seals. The use of a tack-free solid epoxy resin layer therefore permits a broader selection of colors and materials of the barrier layer. Also, metallic surfaces that come in contact with the tack-free solid epoxy resin layer do not have to be subjected to a pretreatment against bitumen corrosion due to aggressive acids produced by oxidation of the bitumen. Furthermore, in the case of the tack-free solid epoxy resin layer the migration of low-molecular substances into the barrier layer materials is less in comparison to bitumen.

Furthermore, such sealing membranes can also be applied onto a substrate even without open flame, which is in particular a technical safety advantage.

Another great advantage, on account of the tack-free solid epoxy resin layer, is the possibility of arranging the sealing membrane in a shiftable manner before the application on the substrate. Once applied to the appropriate location, the sealing membrane can be firmly connected to the substrate by heating the tack-free solid epoxy resin layer.

Further aspects of the invention are subject matter of other independent claims. Especially preferred embodiments of the invention are subject matter of the dependent claims.

### WAYS OF CARRYING OUT THE INVENTION

The present invention relates in a first aspect to a sealing membrane 1 comprising
a thermoplastic barrier layer 2, especially containing thermoplastic polyolefins or polyvinyl chloride (PVC),
as well as a tack-free solid epoxy resin layer 3.

In order to be suited as well as possible as a thermoplastic barrier layer, it should be as water-tight as possible and not decompose or be mechanically damaged during a rather long influencing by water or by moisture. In particular, such sheets like the ones already used in the prior art for sealing purposes in civil engineering are suitable as a thermoplastic barrier layer. In order that the sealing membrane is damaged or altered as little as possible by a heating during an application, it is especially advantageous if the thermoplastic barrier layer is manufactured from a material with a softening point of above 110° C., preferably between 140° C. and 170° C. The thermoplastic barrier layer should advantageously have at least a slight amount of elasticity in order to be able to bridge differences of expansion caused, for example, by temperatures between the sealing membrane and the substrate or tensions caused by fissures in the substrate without the thermoplastic barrier layer being damaged or tearing and the sealing function of the barrier layer being adversely affected.

The thermoplastic barrier layer 2 contains especially preferably materials selected from the group consisting of high-density polyethylene (HDPE), middle-density polyethylene (MDPE), low-density polyethylene (LDPE), polyethylene (PE), polypropylene (PP), polyethylene terephthalate (PET), polystyrene (PS), polyvinylchloride (PVC), polyamides (PA), ethylene vinyl acetate (EVA), chlorosulfonated polyethylene, thermoplastic polyolefins (TPO), ethylene propylene diene rubber (EPDM) and polyisobutylene (PIB) and their mixtures.

The thermoplastic barrier layer preferably consists of more than 50 wt %, especially preferably more than 80 wt % of the previously cited materials.

The thermoplastic barrier layer advantageously has a layer thickness in the millimeter range, typically between 0.2 and 15 mm, preferably between 0.5 and 4 mm.

The concept “solid epoxy resin” is well-known to the epoxy professional and is used in contrast to “liquid epoxy resins”. The glass temperature of solid resins is above room temperature, i.e., they can be comminuted at room temperature to pourable powders.

Preferred solid epoxy resins have the formula (I)

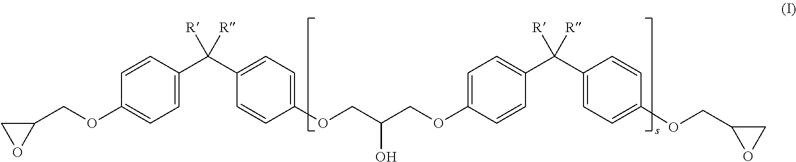

Here the substituents R′ and R″ stand independently of one another either for H or CH₃. Furthermore, the subscript s stands for a value of >1.5, in particular for 2 to 12.

Such solid epoxy resins are commercially available, for example, under the trade series names D.E.R.™ and Araldite 8 and Epikote by Dow or Huntsman or Hexion and are accordingly well known to the professional.

Compounds with the formula (I) with a subscript s between 1 and 1.5 are designated by a professional as semisolid epoxy resins. They are also considered as solid resins for the invention present here. However, epoxy resins in the narrower sense are preferred, i.e., where the subscript s has a value of >1.5.

It was also able to be shown, among other things, that if a liquid epoxy resin is used instead of the solid epoxy resin, the advantages of the present invention do not occur. Thus, it is essential for the essence of the present invention that a solid epoxy resin is present in the adhesive composition.

The concept “tack-free” denotes in connection with the solid epoxy resin layer 3 in the entire present document a surface adhesiveness in the sense of an immediate adhesion or “tack” that is so slight at room temperature that upon pressing with a thumb with an expenditure of pressure of about 5 kg for 1 second on the surface of the solid epoxy resin layer the thumb does not remain adhered to the surface of the solid epoxy resin layer, respectively the solid epoxy resin layer cannot be raised up.

The tack-free solid epoxy resin 3 preferably has an amount of 1-20 wt %, especially 2-12 wt %, preferably 4-9 wt % of solid epoxy resin relative to the total weight of the tack-free solid epoxy resin layer.

The solid epoxy resin of the tack-free solid epoxy resin layer 3 is preferably stable in storage at room temperature.

It is furthermore advantageous if the tack-free solid epoxy resin 3 also has a thermoplastic polymer 4 that is stable at room temperature.

The tack-free solid epoxy resin layer 3 preferably has an amount of 40-90 wt %, especially 50-80 wt % of a thermoplastic polymer 4 that is solid at room temperature.

In this document softening temperatures or softening points are understood in particular as measured according to the ring & ball method according to DIN ISO 4625.

In the present document the concept “room temperature” denotes a temperature of 23° C.

It is very advantageous if the thermoplastic polymer, that is solid at room temperature, has a softening point in the range of 60° C. to 150° C., especially 80° C. to 150° C. and especially preferably 90° C. to 130° C.

Thermoplastic polymers that are solid at room temperature denote in particular homopolymers or copolymers of at least one olefinically unsaturated monomer, in particular of monomers selected from the group consisting of ethylene, propylene, butylene, butadiene, isoprene, acrylonitrile, vinyl ester, especially vinyl acetate, vinyl ether, allyl ether, (meth)acrylic acid, (meth)acrylic acid ester, maleic acid, maleic acid anhydride, maleic acid ester, fumaric acid, fumaric acid ester and styrene.

Copolymers are especially suitable that are produced only from the monomers of the just-cited group.

Furthermore, copolymers of olefinically unsaturated monomers and modified by a grafting reaction, in particular the copolymers of the previous section and modified by a grating reaction, are especially suitable.

Thermoplastics that are solid at room temperature are, for example, polyolefins, especially poly-α-olefins. The most preferred such polyolefins are atactic poly-α-olefins (APAO).

The most preferred thermoplastic polymers are as, ethylene/vinyl acetate copolymers (EVA), in particular those with a vinyl acetate amount of below 50 wt %, in particular with a vinyl acetate amount between 10 and 40 wt %, preferably between 20 and 35 wt %, most preferably between 27 and 32 wt %.

It proved to be especially preferred if at least two different thermoplastic polymers solid at room temperature are used that preferably have a different chemical composition. The most preferred is one of these two different thermoplastic polymers that is an ethylene/vinyl acetate copolymer.

Furthermore, it is advantageous if the other thermoplastic polymer is a copolymer in whose production maleic acid or maleic acid anhydride was used as monomer or as grafting reagent.

The weight ratio of solid epoxy resin to thermoplastic polymer solid at room temperature is preferably between 1:2 and 1:10, preferably between 1:4 and 1:8.

It proved to be especially advantageous if the tack-free solid epoxy resin layer 3 also contains a chemical or physical expanding agent.

If the tack-free solid epoxy resin layer has a chemical or physical expanding agent, the expanding agent is activated upon heating and in particular, a gas is released.

An exothermal thermal expanding agent can be concerned here such as, for example, azo compounds, hydrazine derivatives, semicarbazides or tetrazols. Azo dicarbon amide and oxy-bis-(benzene sulfonyl hydrazide), that release energy during the decomposition are preferred. Endothermal expanding agents such as, for example, sodium bicarbonate/citric acid mixtures are also suitable. Such chemical expanding agents are obtainable, for example, under the name Celogen™ of the Chemtura company. Physical expanding agents like those marketed under the trade name Expancel™ of the Akzo Nobel company are also suitable.

Especially suitable expanding agents are those obtainable under the trade name Expancel™ of the Akzo Nobel company or Celogen™ of the Chemtura company.

Preferred expanding agents are chemical expanding agents that release a gas during heating, especially at a temperature of 100 to 160° C.

The amount of the physical or chemical expanding agent is in particular in the range of 0.1-15 wt % relative to the weight of the tack-free solid epoxy resin layer.

It can furthermore be advantageous to partially pre-foam the tack-free solid epoxy resin layer during the manufacture. This can, for example, save energy during an application on a substrate. Also, the tack-free solid epoxy resin layer is equal to a bituminous layer as regards thickness and haptic perception but is lighter.

Furthermore, the tack-free solid epoxy resin layer can in particular contain epoxy cross-linking catalysts and/or hardeners for epoxy resins that are activated by elevated temperature. In particular, they are selected from the group consisting of dicyandiamide, guanamines, guanidines, amino guanidines and their derivatives; substituted ureas, in particular 3-(3-chloro-4-methylphenyl)-1, 1-dimethyl urea (chlorotoluron), or phenyl-dimethyl ureas, in particular p-chlorophenyl-N,N-dimethyl urea (monuron), 3-phenyl-1, 1-dimethyl urea (fenuron), 3,4-dichlorophenyl-N,N-dimethyl urea (diuron), N,N-dimethyl urea, N-iso-butyl-N′,N′-dimethyl urea, 1,1′-(hexane-1,6-diyl)bis(3,3′-dimethyl urea) as well as imidazoles, imidazole salts, imidazolines and amine complexes. These heat-activatable hardeners can preferably be activated at a temperature of 80-160° C., in particular 85° C. to 150° C., preferably 90-140° C. In particular, dicyandiamide is used in combination with a substituted urea.

The tack-free solid epoxy resin layer , can also contain, in addition to the already mentioned components, further components, for example, biocides, stabilizers, in particular thermal stabilizers, softeners, pigments, adhesion agents, in particular organosilanes, reactive binding agents, solvents, rheology modifiers, fillers or fibers, in particular glass fibers, carbon fibers, cellulose fibers, cotton fibers or synthetic plastic fibers, preferably fibers of polyester or of a homo-or copolymer of ethylene and/or propylene or of viscose. Depending on the design of the tack-free solid epoxy resin layer, the fibers can be used as short fibers or long fibers , or in the form of spun, woven or non-woven fibers materials. The use of fibers is particularly advantageous for improving the mechanical strengthening, in particular if at least a part of the fibers consists of traction-proof or highly traction-proof fibers, in particular of glass, carbon or aramides.

The solid epoxy resin layer 3 preferably contains an amount of 1-20 wt % of an epoxy compound, an amount of 0.1-15 wt % of a chemical or physical expanding agent, an epoxy cross-linking catalyst and/or hardeners for epoxide resins, that are activated by a temperature of 80° C. to 160° C. and contains a portion of an amount of 40-90 wt %-wt % of a solid thermoplastic polymer 4, in particular of an ethylene/vinyl acetate copolymer relative to the total weight of the solid epoxy resin layer.

The tack-free solid epoxy resin layer preferably has a thickness of 0.1-5 mm, especially 0.2-1 mm. If the tack-free solid epoxy resin layer is a partially pre-foamed, tack-free solid epoxy resin layer it preferably has a thickness of 1-10 mm, in particular 2-3 mm.

In order to strengthen the thermoplastic barrier layer 2 or the sealing membrane 1 the sealing membrane can also comprise a fibrous material. Such a fibrous material is typically arranged on the thermoplastic barrier layer, preferably between the thermoplastic barrier layer and the tack-free solid epoxy resin layer. It can be advantageous for the sealing function of the sealing membrane if the fibrous material is embedded in the thermoplastic barrier layer.

The concept ‘fibrous material” denotes in the entire present document a material built up from fibers. The fibers comprise or consist of organic or synthetic material. In particular, the material is cellulose fibers, cotton fibers, protein fibers or synthetic fibers. Especially preferred synthetic fibers are fibers of polyester or from a homo- or copolymer of ethylene and/or propylene or of viscose. The fibers can be short fibers or long fibers, spun, woven or non-woven fibers or filaments. Furthermore, the fibers can be directed or stretched fibers. Furthermore, it can be advantageous to use different fibers with each other in the geometry as well as also in the composition.

The body built up from fibers can be manufactured in very many different methods known to the professional. In particular, bodies are used that are a woven fabric, non-woven fabric or knit fabric. A felt or fleece is especially preferred as fibrous material.

It is advantageous if the thermoplastic barrier layer 2 and the tack-free solid epoxy resin layer 3 are directly connected to one another. “Direct contact” denotes that there is no other layer or substance between two materials , and that the two materials are directly connected to one another or adhere to one another. The two materials can be present mixed into one another at the transition between the two materials. The tack-free solid epoxy resin layer 3 can be connected over the entire surface or discontinuously to the thermoplastic barrier layer 2.

It is furthermore advantageous if sealing membrane 1 is a flexible membrane, in particular a flexible web. This membrane can be readily rolled and thus readily stored or transported. Thus, the sealing membrane arrives at the construction site in a simple manner and can be rolled out there and cut to the required dimensions. This is a very cost-efficient and time-efficient work step. The surface of a sealing membrane is basically tack-free. Nevertheless, it can be advantageous to protect the surface of the sealing membrane, in particular of the tack-free solid epoxy resin layer, with a separating paper, for example, a siliconized paper, in order to be able to exclude the possible risk that during storage time the individual layers of a roll adhere to each other.

Another aspect of the present invention relates to a method for sealing a substrate 5 comprising the steps:
(i) Application of a sealing membrane as it was previously described on a substrate 5, whereby the side of the tack-free solid epoxy resin layer 3 faces the substrate 5;
(ii) Heating the tack-free solid epoxy resin layer 3 of the sealing membrane 1, preferably to a temperature of 80-600° C.

The substrate 5 is preferably a civil engineering structure to be sealed against moisture and water. It can furthermore be the ground area, a building, an insulation material or a shell. The substrate 5 can be horizontal or not.

In particular, the material of the substrate is wood, metal, a metal alloy, a mineral binding agent such as concrete or gypsum, plastic or a thermal insulation agent such as foamed polyurethane, mineral wool or foamed glass (foam glass).

The application of the sealing membrane on a substrate 5 in step (i) can take place, for example, by unrolling the sealing membrane or by a full-area placing of the sealing membrane. Due to the fact that the surface of the solid epoxy resin layer 3 is tack-free, the sealing membrane can be readily (re-)positioned on the substrate until the heating in step (ii).

The heating can take place in any manner. The heating can be made by external or by internal heat sources such as an exothermal chemical reaction. The heating is preferably carried out in step (ii) by hot air, flame, ultrasound, induction welding or by an electrical resistance heating element.

The tack-free solid epoxy resin layer 3 can be directly heated, for example, by heating the surface of the tack-free solid epoxy resin layer facing away from the thermoplastic barrier layer, in particular by hot air or flame. A direct heating is also possible by an electrical heating resistance element, for example, with an electrical resistance heating element, for example, a metallic net, arranged in the tack-free solid epoxy resin layer.

Additionally or alternatively, the tack-free solid epoxy resin layer 3 can also be indirectly heated, for example, by heating the surface of the thermoplastic barrier layer, in particular by welding devices, hot air or flame. An indirect heating is also possible by heating the substrate, typically by hot air or flame.

If the heating takes place by flame, it is advantageous if the surface of the tack-free solid epoxy resin layer is heated for 0.1-30 seconds, in particular, 5-20 seconds, preferably 10-15 seconds to a temperature of 400° C.-600° C., in particular , 450° C.-550° C., in particular, 480° C.-520° C.

The heating in step (ii) can be carried out at a time before and/or during and/or after the step (i). If the heating in step (ii) takes place in time before the step (i), this typically takes place shortly before the application in step (i).

During the heating of the tack-free solid epoxy resin layer 3 the solid epoxy resin obtained and/or the optionally contained thermoplastic polymer 4 that is solid at room temperature and any other meltable components of the tack-free solid epoxy resin layer begin to melt or melt in accordance with their melting point. If they melt they can form a largely homogeneous layer and can form a boundary phase layer. If the solid epoxy resin layer comprises a chemical or physical expanding agent, the expanding agent is activated during the heating in step (ii) and in particular a gas is released. The structure produced in this manner has the considerable advantage that a long-lasting bond between the individual layers is ensured.

Another aspect of the present invention relates to the usage of the sealing membrane 1 previously described in detail for sealing substrates.

The sealing membrane is typically used as a prefabricated web. In this instance the sealing membrane is preferably manufactured by an industrial process in a sheet plant and arrives at the construction preferably in the form of a sealing membrane for use from a roll. However, the sealing membrane can also be used in the form of braces with a width of typically 1-20 cm, for example, for sealing connection positions between two roof webs. Furthermore, the sealing membrane can also be present and used in the form of flat bodies for repairing damaged spots in seals, for example, roof webs.

A preferred use of the sealing membrane 1 is therefore a use for sealing against moisture of structures in civil engineering, especially of roofs and floors.

Another aspect of the present invention relates to a method for manufacturing a sealing membrane 1 as it was previously described in detail, whereby the thermoplastic barrier layer 2 and/or the tack-free solid epoxy resin layer 3 are manufactured by calendering and/or extrusion and/or co-extrusion and/or lamination.

The thermoplastic barrier layer 2 is preferably connected by calendering and/or co-extrusion to the tack-free solid epoxy resin layer 3. Furthermore, the sealing membrane 1 can be manufactured as an endless item and rolled up, for example, on rolls.

Furthermore, it can be advantageous if the tack-free solid epoxy resin layer 3 is partially foamed during the manufacture. This is typically achieved by physical and/or chemical expanding agents like the ones previously cited, that are optionally contained in the tack-free solid epoxy resin layer 3.

In another aspect the present invention relates to a form body surface comprises a sealing membrane, whereby the sealing membrane is arranged with the side facing away from the thermoplastic barrier layer on the form body. The form body is typically a structure of civil engineering. The concept “form body” denotes an object with a three-dimensional extension.

### SHORT DESCRIPTION OF THE DRAWINGS

Exemplary embodiments of the invention are explained in detail in the following using the drawings. The same elements are provided with the same reference numerals in the various figures.

In the figures:

FIG. 1 shows a cross section through a substrate with partially applied sealing membrane (situation during or after step (ii));

FIG. 2 shows a cross section through a substrate with applied sealing membrane (situation during step (ii));

FIG. 3 shows a cross section through a substrate with applied sealing membrane (situation during step (ii)).

The drawings are schematic. Only the elements essential for a direct understanding of the invention are shown.

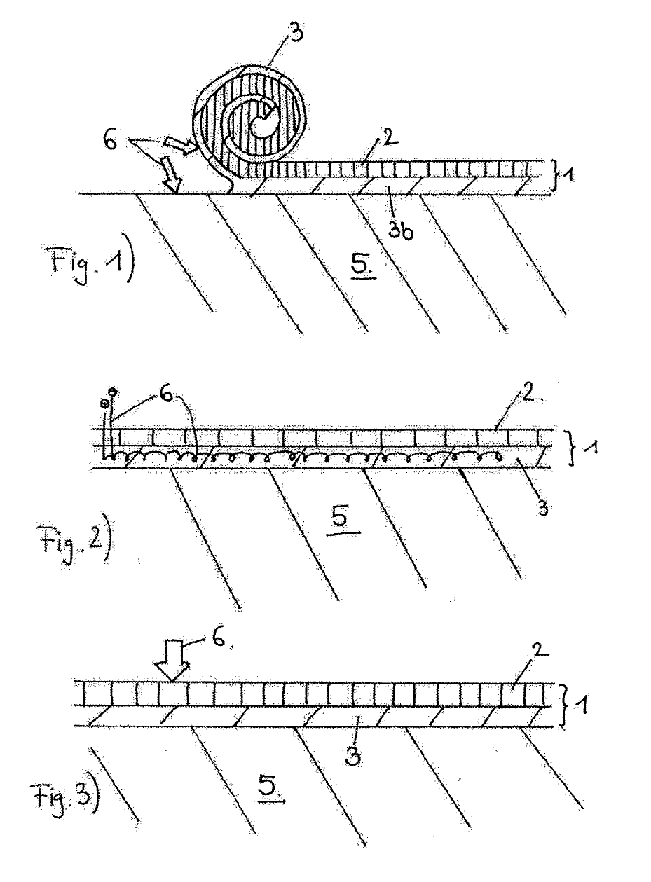

FIG. 1 shows a schematic cross section through a substrate with partially applied sealing membrane 1. The situation during or after the heating in step (ii) is shown. On the one hand an indirect heating by a heat source 6 is shown, whereby the heating takes place by heating the substrate, typically by hot air or flame. The arrows are intended to represent the direction of the emitted heat starting from the heat source. On the other hand, even a direct heating by a heat source is shown in FIG. 1 that typically takes place by hot air or flame. In the situation shown in FIG. 1 the steps (i) of the application of the sealing membrane 1 and step (ii) of the heating of the tack-free solid epoxy resin layer 3 take place substantially at the same time. The tack-free solid epoxy resin layer 3 comprises an expanding agent that is visible in FIG. 1 by a greater thickness of the solid epoxy resin layer after the heating 3b. As a result of the roll shape of the sealing membrane the sealing membrane can be unrolled after an initial positioning of the substrate and the steps (i) and (ii) can be carried out.

FIG. 2 shows a schematic cross section through a substrate with applied sealing membrane 1. The situation during the heating in step (ii) after the application of the sealing membrane on the substrate 5 is shown. The direct heating takes place by an electrical resistance heating element (heat source 6) arranged in the tack-free solid epoxy resin layer 3.

FIG. 3 shows a schematic cross section through a substrate with applied sealing membrane 1. The situation during the heating in step (ii) after the application of the sealing membrane on the substrate 5 is shown. The indirect heating takes place by a heating device 6 that ensures a charge of heat through the barrier layer 2 into the tack-free solid epoxy resin layer 3.

The arrow represents the direction of the emitted heat emanating from the heat source. Possible heat sources are, for example, welding devices, hot air, flame or ultrasound.

### LIST OF REFERENCE NUMERALS

1 sealing membrane
2 thermoplastic barrier layer
3 tack-free solid epoxy resin layer
3b solid epoxy resin layer after the heating
5 substrate
6 heat source, respective direction of the emitted heat emanating from the heat source

1. A sealing membrane comprising
a thermoplastic barrier layer, having thermoplastic polyolefins or polyvinyl chloride (PVC), and a tack-free solid epoxy resin layer.

2. The sealing membrane according to claim 1, wherein the thermoplastic barrier layer contains materials selected from the group consisting of high-density polyethylene (HDPE), middle-density polyethylene (MDPE), low-density polyethylene (LDPE), polyethylene (PE), polypropylene (PP), polyethylene terephthalate (PET), polystyrene (PS), polyvinylchloride (PVC), polyamides (PA), ethylene vinyl acetate (EVA), chlorosulfonated polyethylene, thermoplastic polyolefins (TPO), ethylene propylene diene rubber (EPDM) and polyisobutylene (PIB) and their mixtures.

3. The sealing membrane according to claim 1, wherein the solid epoxy resin of the tack-free solid epoxy resin layer is storage-stable at room temperature.

4. The sealing membrane according to claim 1, wherein the tack-free solid epoxy resin layer has an amount of 1-20 wt %, especially 2-12 wt %, preferably 4-9 wt % of solid epoxy resin relative to the total weight of the solid epoxy resin layer.

5. The sealing membrane according to claim 1, wherein the tack-free solid epoxy resin layer contains a chemical or physical expanding agent.

6. The sealing membrane according to claim 1, wherein the tack-free solid epoxy resin layer also contains a thermoplastic polymer that is solid at room temperature.

7. The sealing membrane according to claim 6, wherein the thermoplastic polymer, that is solid at room temperature, has a softening point in the range of 60° C. to 150° C., especially of 80° C. to 150° C.

8. The sealing membrane according to claim 6, wherein the thermoplastic polymer, that is solid at room temperature, is an ethylene/vinylactate copolymer.

9. The sealing membrane according to claim 6, wherein the weight ratio of solid epoxy resin to thermoplastic polymer solid at room temperature is between 1:2 and 1:10, preferably between 1:4 and 1:8.

10. The sealing membrane according to claim 1, wherein the thermoplastic barrier layer and the tack-free solid epoxy resin layer are directly connected to one another.

11. The sealing membrane according to claim 1, wherein the tack-free solid epoxy resin layer has a thickness of 0.1-5 mm.

12. A method for sealing a substrate comprising the steps:
(i) applying a sealing membrane according to claim 1 on a substrate, wherein the side of the tack-free solid epoxy resin layer faces the substrate; and
(ii) heating the tack-free solid epoxy resin layer of the sealing membrane, preferably to a temperature of 80-600° C.

13. A method for manufacturing a sealing membrane according to claim 1, wherein the thermoplastic barrier layer 2 and/or the tack-free solid epoxy resin layer are manufactured by calendering and/or extrusion and/or co-extrusion and/or lamination.

14. A form body whose surface comprises a sealing membrane according to one of claim 1, wherein the sealing membrane is arranged on the form body with its side facing away from the thermoplastic barrier layer.
